(19) United States
(12) Patent Application Publication
(10) Pub. No.: US 2009/0272041 A1
(43) Pub. Date: Nov. 5, 2009

(54) METHOD OF MAKING A CBN COMPACT

(76) Inventors: Cornelius Johannes Pretorius, Co. Clare (IE); Nedret Can, Boksburg (ZA); Peter Michael Harden, Limerick (IE)

Correspondence Address: FROMMER LAWRENCE & HAUG, 745 FIFTH AVENUE- 10TH FL., NEW YORK, NY, 10151, US

(21) Appl. No.: 12/297,739

(22) PCT Filed: Apr. 23, 2007
(86) PCT No.: PCT/IB07/01045

§ 371 Date: Jun. 30, 2009

(30) Foreign Application Priority Data
Apr. 21, 2006 (ZA) 2006/03211

(51) Int. Cl. C09K 3/14

(52) U.S. Cl. 51/307

(57) ABSTRACT

A layer of a refractory material produced and bonded in situ to a surface of a CBN compact during the high temperature/high pressure manufacture of the CBN compact.

### BACKGROUND OF THE INVENTION

This invention relates to a method of making a CBN compact.

Boron nitride exists typically in three crystalline forms, namely cubic boron nitride (CBN), hexagonal boron nitride (hBN) and wurtzitic cubic boron nitride (wBN). Cubic boron nitride is a hard zinc blend form of boron nitride that has a similar structure to that of diamond. In the CBN structure, the bonds that form between the atoms are strong, mainly covalent tetrahedral bonds. Methods for preparing CBN are well known in the art. One such method is subjecting hBN to very high pressures and temperatures, in the presence of a specific catalytic additive material, which may include the alkali metals, alkaline earth metals, lead, tin and nitrides of these metals. When the temperature and pressure are decreased, CBN may be recovered.

CBN has wide commercial application in machining tools and the like. It may be used as an abrasive particle in grinding wheels, cutting tools and the like or bonded to a tool body to form a tool insert using conventional electroplating techniques.

CBN may also be used in bonded form as a CBN compact, also known as PCBN. CBN compacts tend to have good abrasive wear, are thermally stable, have a high thermal conductivity, good impact resistance and have a low coefficient of friction when in contact with a ferrous workpiece.

Diamond is the only known material that is harder than CBN. However, as diamond tends to react with certain materials such as iron, it cannot be used when working with iron containing metals and therefore use of CBN in these instances is preferable.

CBN compacts comprise sintered polycrystalline masses of CBN particles. When the CBN content exceeds 80 percent by volume of the compact, there is a considerable amount of direct CBN-to-CBN contact and bonding. When the CBN content is lower, e.g. in the region of 40 to 60 percent by volume of the compact, then the extent of direct CBN-to-CBN contact and bonding is less.

CBN compacts will generally also contain a binder or second phase which may be a CBN catalyst or may contain such a catalyst. Examples of suitable binder/second phases are aluminium, alkali metals, cobalt, nickel, and tungsten.

When the CBN content of the compact is less than 75 percent by volume there is generally present another hard phase, a third phase, which may be ceramic in nature. Examples of suitable ceramic hard phases are nitrides, borides and carbonitrides of a Group IVA or VB transition metal, aluminium oxide, and carbides such as tungsten carbide and mixtures thereof.

CBN compacts may be bonded directly to a tool body in the formation of a tool insert or tool. However, for many applications it is preferable that the compact is bonded to a substrate, forming a supported compact structure, and then the supported compact structure is bonded to a tool body. The substrate is typically a cemented metal carbide that is bonded together with a binder such as cobalt, nickel, iron or a mixture or alloy thereof. The metal carbide particles may comprise tungsten, titanium or tantalum carbide particles or a mixture thereof. The substrate, when provided, will generally have a size and thickness considerably greater than that of the CBN compact.

A known method for manufacturing the polycrystalline CBN compacts and supported compact structures involves subjecting an unsintered mass of CBN particles to high temperature and high pressure conditions, i.e. conditions at which the CBN is crystallographically stable, for a suitable time period. A binder phase may be used to enhance the bonding of the particles. Typical conditions of high pressure and temperature (HPHT) which are used are pressures of the order of 2 GPa or higher and temperatures in the region of 1100° C. or higher. The time period for maintaining these conditions is typically about 3 to 120 minutes.

The sintered CBN compact, with or without substrate, is often cut into the desired size and/or shape of the particular cutting or drilling tool to be used and then mounted onto a tool body utilising brazing techniques.

### SUMMARY OF THE INVENTION

According to the present invention, there is provided a method of making a CBN compact having a layer of a refractory material bonded to a surface thereof including the steps of producing a reaction mass by placing a mass of CBN particles in contact with a material capable of forming the layer of refractory material, and subjecting the reaction mass to elevated temperature and pressure conditions suitable to form a CBN compact.

Thus, the invention provides an in-situ method of producing a CBN compact having a layer of refractory material bonded to a surface thereof. There is no need for a post-sintering operation to apply the layer of refractory material to the CBN compact. Such post-sintering operation adds to the cost and can cause degradation or damage to the CBN compact. Adequate bonding of the refractory material to the CBN compact can also be difficult to achieve in a post-sintering operation.

The nature of the refractory material for the layer will vary according to the application to which the CBN compact is to be put. For example, if the layer is intended to reduce the crater damage to a working surface of the CBN compact in a cutting operation, then the refractory will be chosen to have a higher crater resistance than the CBN compact.

The refractory material will typically be a carbide, nitride, carbonitride, oxide, boride, or silicide, preferably of a Group 4, 5 or 6 metal or aluminium or silicon. The refractory material may be as a mixture or solid solution of such refractory materials.

The refractory material will typically have a binder present, generally in an amount of less than 20 volume percent of the refractory material. Examples of suitable binders are transition metals such as cobalt, iron, nickel, yttrium and titanium, and copper, aluminium and silicon and compounds and alloys containing such a metal.

In one form of the invention, the refractory-forming material in the reaction mass takes the form of a layer in contact with the mass of CBN particles. The layer preferably has a coherent green state form.

The layer of refractory-forming material in the reaction mass may be formed of two or more different layers with different compositions.

In another form of the invention the reaction mass is produced by placing the mass of CBN particles in a container of a refractory-forming material. The container may be made of a metal selected from titanium, niobium, tungsten, molybdenum, aluminium, hafnium, iron, cobalt, nickel, chromium, vanadium, zirconium and tantalum or alloy containing such a metal. During the application of the elevated temperature and pressure, the material of the container reacts with the CBN particles forming nitrides and/or borides and thus forms a layer of this refractory material bonded to a surface of the CBN compact. In the case where a metal alloy is employed as the canister material, then one of the alloying elements can be selected to facilitate the formation of an appropriate binder phase for the refractory material. Examples of suitable elements for this are nickel and cobalt. The element may persist in the metallic form within the final sintered product. The thickness of such layers is typically about 20 to 50 microns, the depth to which boron and nitrogen from the CBN particles diffuses into the container material. Some residual metal from the container may remain in the layer of refractory material and act as a binder phase.

The layer of refractory material bonded to a surface of the CBN compact will generally be thin and preferably no greater than 300 microns in thickness. Generally, the thickness of the layer will be at least 30 microns. For such layers, the thickness of the layer of refractory-forming material in the reaction mass will be chosen such as to produce a refractory layer of the desired thickness.

A layer of a metal such as copper, silver, zinc, cobalt and nickel may be provided between the refractory material and the mass of CBN particles in the reaction mass. The purpose of such a metal may, for example, be to improve the bonding between the layer of refractory material and the CBN compact.

Typical conditions of elevated (high) pressure and temperature (HPHT) which are used to produce a CBN compact are temperatures in the region of 1100° C. or higher and pressures of the order of 2 GPa or higher. The time period for maintaining these conditions is typically about 3 to 120 minutes.

The CBN compact may be a high content CBN compact, i.e. one having a CBN content of at least 70 percent by volume, and will generally contain a second phase. The CBN compact may also be a low CBN content compact which will contain a second phase and generally also a third phase. Both such CBN compacts are well known in the art.

Second and third phase materials, when provided, will generally be in particulate form and then mixed with the mass of CBN particles prior to the application of the elevated temperature and pressure conditions.

The mass of CBN particles, with or without particulate second and third phases, will preferably be formed into a coherent green state compact which is then subjected to the elevated temperature and pressure conditions.

The CBN compact may be bonded to a substrate such as a cemented carbide substrate. For such compacts, the cemented carbide substrate will be massive relative to the CBN compact and the layer of refractory material will generally be bonded to a surface of the compact opposite to that bonded to the substrate.

The CBN compact typically has a thickness range from about 300 μm to 2000 μm, preferably from about 500 μm to 1000 μm.

### DETAILED DESCRIPTION OF PREFERRED EMBODIMENTS

The invention will now be illustrated by the following non-limiting examples.

### Example 1

A sub-stochiometric titanium carbonitride powder, Ti(C_{0.7}NO_{0.3})_{0.8} of average particle size of 1.4 micron was mixed with Al powder, average particle size of 5 micron, using a tubular mixer. The mass ratio between Ti(C_{0.7}N_{0.3})_{0.8} and Al was 90:10. The powder mixture was pressed into a titanium cup to form a green compact and heated to 1025° C. under vacuum for 30 minutes and then crushed and pulverized. The powder mixture was then attrition milled for 4 hours and then 1.4 micron average particle size of CBN was added and attrition milled in hexane for an hour. The CBN was added in an amount such that the total volume percentage of calculated CBN in the mixture was about 60 percent. The slurry was dried under vacuum and formed into a green compact, which was supported by a tungsten carbide hard metal.

The green compact and support of tungsten carbide were placed in a titanium canister and sintered at 55 kbar (5.5 GPa) and at a temperature around 1300° C. The canister was recovered and unreacted titanium was removed by grinding. A thin layer of a refractory material containing titanium diboride and titanium nitride was left on at least one surface of the CBN compact. This layer of refractory was formed by interaction of the titanium with boron and nitrogen diffusing into the titanium cup from the CBN particles. The depth of the diffusion is typically 20 to 50 microns. Some residual titanium may be present in the refractory layer, acting as a binder.

### Example 2

A sub-stochiometric titanium carbonitride powder, Ti(C_{0.7}N_{0.3})_{0.8} of average particle size of 1.4 micron was mixed with Al powder, average particle size of 5 micron, using a tubular mixer. The mass ratio between Ti(C_{0.7}N_{0.3})_{0.8} and Al was 90:10. The powder mixture was pressed into a titanium cup to form a green compact and heated to 1025° C. under vacuum for 30 minutes and then crushed and pulverized. The powder mixture was then attrition milled for 4 hours and then 1.4 micron average particle size of CBN was added and attrition milled in hexane for an hour. The CBN was added in an amount such that the total volume percentage of calculated CBN in the mixture was about 60 percent. The slurry was dried under vacuum and formed into a green compact.

A powder mixture containing about 89 vol % TiC_{0.8}, and equal volume percentage of Al and Ni, was milled and mixed in an attritor mill and dried. A binder, PMMA (poly methyl methacylate), a plastisizer, DBP (dibutyl phthalate) of equal volume percentages were added into a container together with 50 vol % of total volume of the solvent material, containing 70 vol % methyl ethyl ketone and 30 vol % ethanol. The mixture was stirred at high speeds and then a powder mixture, containing TiC_{0.8}, Al and Ni, was added gradually into the liquid mixture to achieve a consistent viscosity that is suitable for tape casting. The mixed slurry was poured into a Dr. Blade set up and a thin layer (about 100 micron in thickness) of ceramic tape was cast and dried. After drying, layers of ceramic (refractory) tape were placed on top of the already formed green compact. After encapsulation, the unit was sintered at 55 kbar (5.5 GPa) and at a temperature around 1300° C.

Recovered after sintering was a CBN compact having a layer of a refractory material containing titanium carbide, titanium diboride, aluminium nitride and nickel alloy, bonded to a surface thereof.

### Example 3

A sub-stochiometric titanium carbonitride powder, Ti(C_{0.7}N_{0.3})_{0.8} of average particle size of 1.4 micron was mixed with Al powder, average particle size of 5 micron, using a tubular mixer. The mass ratio between Ti(C_{0.7}N_{0.3})_{0.8} and Al was 90:10. The powder mixture was pressed into a titanium cup to form a green compact and heated to 1025° C. under vacuum for 30 minutes and then crushed and pulverized. The powder mixture was then attrition milled for 4 hours and then 1.4 micron average particle size of CBN was added and attrition milled in hexane for an hour. The CBN was added in an amount such that the total volume percentage of calculated CBN in the mixture was about 60 percent. The slurry was dried under vacuum and formed into a green compact.

A powder mixture containing about 63.5 vol % TiC_{0.8}, 30 vol % CBN, 2.6 vol % Al and 3.9 vol % of Ni was milled and mixed in an attritor mill and dried. A binder, PMMA (poly methyl methacylate), a plastisizer, DBP (dibutyl phthalate) of equal volume percentages were added into a container together with 50 vol % of total volume of the solvent material, containing 70 vol % methyl ethyl ketone and 30 vol % ethanol. The mixture was stirred at high speeds and then the powder mixture, containing TiC_{0.8}, CBN, Al and Ni, was added gradually into the liquid mixture to achieve a consistent viscosity that is suitable for tape casting. The mixed slurry was poured into a Dr. Blade set up and a thin layer (about 100 micron in thickness) of ceramic tape was cast and dried. After drying, layers of ceramic tape were placed on top of the already formed green compact. After encapsulation, the unit was sintered at 55 kbar (5.5 GPa) and at a temperature around 1300° C.

Recovered was a CBN compact having a layer of a refractory containing titanium carbide, CBN, titanium diboride, aluminium nitride and nickel alloy bonded to a surface thereof.

### Example 4

A sub-stochiometric titanium carbonitride powder, Ti(C_{0.7}N_{0.3})_{0.8} of average particle size of 1.4 micron was mixed with Al powder, average particle size of 5 micron, using a tubular mixer. The mass ratio between Ti(C_{0.7}N_{0.3})_{0.8} and Al was 90:10. The powder mixture was pressed into a titanium cup to form a green compact and heated to 1025° C. under vacuum for 30 minutes and then crushed and pulverized. The powder mixture was then attrition milled for 4 hours and then 1.4 micron average particle size of CBN was added and attrition milled in hexane for an hour. The CBN was added in an amount such that the total volume percentage of calculated CBN in the mixture was about 60 percent. The slurry was dried under vacuum and formed into a green compact.

A powder mixture containing about 46.9 vol % TiN_{0.8}, 46 vol % CBN, 3.1 vol % Ni and 4 vol % Al was milled and mixed in an attritor mill and dried. A binder, PMMA (poly methyl methacylate), a plastisizer, DBP (dibutyl phthalate) of equal volume percentages were added into a container together with 50 vol % of total volume of the solvent material, containing 70 vol % methyl ethyl ketone and 30 vol % ethanol. The mixture was stirred at high speeds and then a powder mixture, containing TiN_{0.8}, CBN, Al and Ni, was added gradually into the liquid mixture to achieve a consistent viscosity that is suitable for tape casting. The mixed slurry was poured into a Dr. Blade set up and a thin layer (about 100 micron in thickness) of ceramic tape was cast and dried. After drying, layers of ceramic tape were placed on top of the already formed green compact. After encapsulation, the unit was sintered at 55 kbar (5.5 GPa) and at a temperature around 1300° C.

Recovered was a CBN compact having a layer of a refractory material containing titanium nitride, CBN, titanium diboride, aluminium nitride and nickel alloy bonded to a surface thereof.

### Example 5

A sub-stochiometric titanium carbonitride powder, Ti(C_{0.7}N_{0.3})_{0.8} of average particle size of 1.4 micron was mixed with Al powder, average particle size of 5 micron, using a tubular mixer. The mass ratio between Ti(C_{0.7}N_{0.3})_{0.8} and Al was 90:10. The powder mixture was pressed into a titanium cup to form a green compact and heated to 1025° C. under vacuum for 30 minutes and then crushed and pulverized. The powder mixture was then attrition milled for 4 hours and then 1.4 micron average particle size of CBN was added and attrition milled in hexane for an hour. The CBN was added in an amount such that the total volume percentage of calculated CBN in the mixture was about 60 percent. The slurry was dried under vacuum and formed into a green compact.

A powder mixture containing about 90.7 vol % Ti(C_{0.5}N_{0.5})_{0.8}, 4.6 vol % Ni and 4.7 vol % Al was milled and mixed in an attritor mill and dried. A binder, PMMA (poly methyl methacylate), a plastisizer, DBP (dibutyl phthalate) of equal volume percentages were added into a container together with 50 vol % of total volume of the solvent material, containing 70 vol % methyl ethyl ketone and 30 vol % ethanol. The mixture was stirred at high speeds and then a powder mixture, containing Ti(C_{0.5}N_{0.5})_{0.8}, Ni and Al was added gradually into the liquid mixture to achieve a consistent viscosity that is suitable for tape casting. The mixed slurry was poured into a Dr. Blade set up and a thin layer (about 100 micron in thickness) of ceramic tape was cast and dried. After drying, layers of ceramic tape were placed on top of the already formed green compact. After encapsulation, the unit was sintered at 55 kbar (5.5 GPa) and at a temperature around 1300° C.

Recovered was a CBN compact having a layer of a refractory material containing titanium carbonitride, titanium diboride, nickel alloy and aluminium nitride bonded to a surface thereof.

### Example 6

A sub-stochiometric titanium carbonitride powder, Ti(C_{0.7}N_{0.3})_{0.8} of average particle size of 1.4 micron was mixed with Al powder, average particle size of 5 micron, using a tubular mixer. The mass ratio between Ti(C_{0.7}N_{0.3})_{0.8} and Al was 90:10. The powder mixture was pressed into a titanium cup to form a green compact and heated to 1025° C. under vacuum for 30 minutes and then crushed and pulverized. The powder mixture was then attrition milled for 4 hours and then 1.4 micron average particle size of CBN was added and attrition milled in hexane for an hour. The CBN was added in an amount such that the total volume percentage of calculated CBN in the mixture was about 60 percent. The slurry was dried under vacuum and formed into a green compact.

A powder mixture containing about 31.5 vol % TiN_{0.8}, 61.7 vol % ZrO₂, 1.4 vol % Al₂O₃ and 5.5 vol % Y₂O₃ was milled and mixed in an attritor mill and dried. A binder, PMMA (poly methyl methacylate), a plastisizer, DBP (dibutyl phthalate) of equal volume percentages were added into a container together with 50 vol % of total volume of the solvent material, containing 70 vol % methyl ethyl ketone and 30 vol % ethanol. The mixture was stirred at high speeds and then a powder mixture, containing TiN_{0.8}, ZrO₂, Al₂O₃ and Y₂O₃, was added gradually into the liquid mixture to achieve a consistent viscosity that is suitable for tape casting. The mixed slurry was poured into a Dr. Blade set up and a thin layer (about 100 micron in thickness) of ceramic tape was cast and dried. After drying, layers of ceramic tape were placed on top of the already formed green compact. After encapsulation, the unit was sintered at 55 kbar (5.5 GPa) and at a temperature around 1300° C.

Recovered was a CBN compact having a layer of a refractory material containing titanium nitride, zirconium oxide, aluminium oxide and yttrium oxide bonded to a surface thereof.

1. A method of making a CBN compact having a layer of a refractory material bonded to a surface thereof includes the steps of producing a reaction mass by placing a mass of CBN particles in contact with a material capable of forming the layer of refractory material, and subjecting the reaction mass to elevated temperature and pressure conditions suitable to form a CBN compact.

2. A method according to claim 1 wherein the refractory-forming material is provided as layer in contact with the mass of CBN particles.

3. A method according to claim 2 wherein the layer is in a coherent green state form.

4. A method according to claim 1 wherein the refractory material is selected from carbides, borides, carbonitrides, nitrides, oxides and suicides.

5. A method according to claim 4 wherein the carbide, carbonitride, nitride, boride, oxide or suicide is of a metal selected from a Group 4, 5 and 6 metal, aluminium and silicon.

6. A method according to claim 1 wherein the refractory material contains a binder.

7. A method according to claim 6 wherein the binder is selected from a transition metal copper, aluminium and silicon and alloys and compounds containing such a metal.

8. A method according to claim 6 wherein the binder is present in an amount of less than 20 percent by volume of the refractory material.

9. A method according to claim 1 wherein the reaction mass is produced by placing the mass of CBN particles in a container of a refractory-forming material, at least a portion of the container reacting with the CBN particles in the reaction mass under the conditions of elevated temperature and pressure to form a layer of refractory material on the CBN compact.

10. A method according to claim 9 wherein the container is made of a metal selected from titanium, niobium, tungsten, molybdenum, aluminium, hafnium, iron, nickel, cobalt, chromium, vanadium, zirconium and tantalum or alloy containing such a metal.

11. A method according to claim 1 wherein the layer of refractory-forming material bonded to the CBN compact has a thickness of no greater than 300 microns.

12. A method according to claim 11 wherein the layer of refractory-forming material has a thickness in the range 30 to 300 microns.

13. A method according to claim 1 wherein the mass of CBN particles is in a coherent green state form in the reaction mass.

14. A method according to claim 1 wherein the mass of CBN particles in the reaction mass is mixed with a second phase material in particulate form.

15. A method according to claim 1 wherein the conditions of elevated temperature and pressure are a temperature of at least 1100 degrees centigrade and a pressure of at least 2 GPa.

16. A method according to claim 15 wherein the conditions of elevated temperature and pressure are maintained for a period of 3 to 120 minutes.

17. A method according to claim 1 substantially as herein described with reference to any one of the Examples.
